(19) United States
(12) Patent Application Publication
(10) Pub. No.: US 2004/0075488 A1
(43) Pub. Date: Apr. 22, 2004

(54) Semiconductor device having voltage feedback circuit therein, and electronic apparatus using the same

(76) Inventors: Isao yamamoto, Ukyo-Ku (JP); Hiroyuki Ishikawa, Ukyo-Ku (JP); Koichi Miyanaga, Ukyo-Ku (JP)

Correspondence Address: CANTOR COLBURN LLP, 55 Griffin Road South, Bloomfield, CT, 06002, US

(21) Appl. No.: 10/677,791

(22) Filed: Oct. 2, 2003

(30) Foreign Application Priority Data
Oct. 4, 2002 (JP) JP2002-292513
Sep. 12, 2003 (JP) JP2003-322295

(51) Int. Cl. G05F 1/10

(52) U.S. Cl. 327/541

(57) ABSTRACT

When a double wire is used in a semiconductor device, it is difficult to detect the open failure of one of two wires. It is intended that this detection be carried out with a weak current and that the load regulation of the semiconductor device be improved. A series regulator is incorporated into an IC chip. A battery voltage is applied to an input pin. The output of a transistor that constitutes the regulator appears at an output pin via an output pad. A feedback signal of an output voltage appears at one end of a voltage-dividing resistor. The output pad is connected with a feedback pad via a protective resistor or diode.

### BACKGROUND OF THE INVENTION

1. Field of the Invention

The present invention relates to semiconductor devices having therein voltage feedback circuits that feed back the output voltage and also relates to electronic apparatus utilizing such semiconductor devices.

2. Description of the Related Art

Japanese Patent Application Laid-Open No. 2001-274332, for example, discloses a semiconductor device using an IC chip provided with a constant-voltage output circuit, in which a feedback pad, in addition to an output pad, is mounted on the IC chip and those pads are connected to the output pin of the semiconductor device via their respective bonding wires in order to improve the load regulation (output voltage-output current characteristics).

In this conventional semiconductor device, the output voltage at the output pin of the semiconductor device is fed back as a feedback voltage to the constant-voltage output circuit. Accordingly, the feedback voltage does not include the voltage drop in the bonding wire connecting the output pad of the IC chip to the output pin, so that the load regulation is improved by the amount of the voltage drop.

However, in these conventional semiconductor devices, the output pad and feedback pad of the IC chip are separately connected to the output pin, and therefore feedback will not be performed if the connection between the feedback pad and the output pin is severed by faulty connection or broken wire.

In such a case, the constant-voltage output circuit determines the output voltage to be zero and works to raise the output voltage. As a result, a highest output voltage is outputted from the semiconductor device, which can damage a load device.

When the current supplied from the semiconductor device to the load is large or when the distance from the semiconductor device to the load is long, the resulting voltage drop will worsen the load regulation at the input end of the load.

### SUMMARY OF THE INVENTION

The present invention has been made in view of the foregoing circumstances and an object thereof is to provide a semiconductor device that includes a feedback circuit to prevent any abnormal rise in output voltage due to defective connection of the feedback circuit as well as to improve the load regulation, and an electronic equipment provided with such a semiconductor device.

A semiconductor device according to the present invention includes: an IC chip which includes: a control circuit which, based on an input signal and a feedback signal in which an output voltage is fed back, controls the output voltage; an output pad for outputting the output voltage; and a feedback pad for inputting the feedback signal; and a protective resistor connected between the output pad and the feedback pad.

An electronic apparatus according to the present invention comprises: (1) a semiconductor device which includes: an IC chip including: a control circuit which, based on an input signal and a feedback signal in which an output voltage is fed back, controls the output voltage; an output pad for outputting the output voltage; a feedback pad for inputting the feedback signal; and a protective resistor connected between the output pad and the feedback pad; and which includes an output terminal connected to the output pad; and a feedback terminal connected to the feedback pad; (2) a load device which includes an input terminal; (3) an output interconnection which connects the output terminal with the input terminal of the load device and which supplies an output of the semiconductor device to the load device; and (4) a feedback interconnection which connects the feedback terminal with the input terminal of the load device or the output interconnection and which feeds back a voltage supplied to the load device, to the semiconductor device.

An electronic apparatus according to another embodiment of the present invention comprises: (1) a semiconductor device which includes: an IC chip including: a control circuit which, based on an input signal and a feedback signal in which an output voltage is fed back, controls the output voltage; an output pad for outputting the output voltage; and a feedback pad for inputting the feedback signal; and which includes an output terminal connected to the output pad; and a feedback terminal connected to the feedback pad; (2) a load device which includes an input terminal; (3) an output interconnection which connects the output terminal with the input terminal of the load device and which supplies an output of the semiconductor device to the load device; (4) a feedback interconnection which connects the feedback terminal with the input terminal of the load device or the output interconnection and which feeds back a voltage supplied to the load device, to the semiconductor device; and (5) a protective resistor connected between the output interconnection and the feedback interconnection.

A semiconductor device according to still another preferred embodiment of the present invention includes: an IC chip which includes a first pad and a second pad; and a terminal connected to both the first pad and the second pad, wherein a fist signal connected to the first pad and a second signal connected to the second pad are coupled by a diode.

When a wire open failure is caused, a circuit connected to the first or second signal ceases to operate in the IC chip. Also, when a reduced voltage test or a test by a low supply voltage is carried out, the error makes its appearance earlier than in the normal due to a forward voltage drop or Vf of the diode, so that the failure can be detected. The use of a diode or diodes allows the test to be carried out even with a weak current.

When the terminal in this semiconductor device is an input terminal, the semiconductor device may further include: a control circuit which generates a target voltage from a power supply voltage when the power supply voltage is applied to the input terminal; and an output terminal which outputs the thus generated target voltage, and the control circuit may be structured such that the power supply voltage is received by two systems of the fist signal and the second signal so as to generate the target voltage by the two systems.

When the terminal in this semiconductor device is an output terminal, the semiconductor device according to another preferred embodiment may further include: an input terminal to which a predetermined power supply voltage is applied; and a control circuit which generates a target voltage from the power supply voltage, and the target voltage may be applied to either the first signal or the second signal.

A semiconductor device according to still another preferred embodiment of the present invention includes: an input terminal to which a power supply voltage is applied; a control circuit which generates a target voltage from the power supply voltage; and an output terminal which outputs the thus generated target voltage, and at an IC chip side there are provided a plurality of pads for use with at least one of the input terminal and the output terminal, so as to have duplicated signal transmission paths for the at least one of the input terminal and the output terminal, and a diode is coupled between the duplicated signal transmission paths therefor.

Still another preferred embodiment according to the present invention relates to an electronic apparatus. This electronic apparatus is equipped with a semiconductor device and a load device. The semiconductor device includes: an input terminal to which a power supply voltage is applied; a control circuit which generates a target voltage from the power supply voltage; and an output terminal which outputs the thus generated target voltage. At an IC chip side there are provided a plurality of pads for use with at least one of the input terminal and the output terminal, so as to have duplicated signal transmission paths for the at least one of the input terminal and the output terminal, and the duplicated signal transmission paths therefor are coupled by a diode at points inside the semiconductor device or between the semiconductor device and the load device.

It is to be noted that any arbitrary combination of the above-described structural components and expressions changed between a method, an apparatus, a system, a computer program, a recording medium and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a structure of a semiconductor device according to a first embodiment of the present invention.

FIG. 2 shows a structure of a semiconductor device according to a second embodiment of the present invention.

FIG. 3 shows a structure of electronic apparatus according to a third embodiment of the present invention.

FIG. 4 shows a structure of a semiconductor device according to a fourth embodiment of the present invention.

FIG. 5 shows a structure of electronic apparatus according to a fifth embodiment of the present invention.

FIG. 6 shows a structure of electronic apparatus according to a sixth embodiment of the present invention.

FIG. 7 shows a structure of an audio signal output apparatus of a BTL configuration according to a seventh embodiment of the present invention.

FIG. 8 shows a structure of a semiconductor device according to an eighth embodiment of the present invention.

FIG. 9 shows a detecting principle of a wire open failure in a semiconductor device according to the eighth embodiment.

FIG. 10 shows a structure of a semiconductor device according to a ninth embodiment of the present invention.

FIG. 11 shows a structure of a semiconductor device according to a tenth embodiment of the present invention.

FIG. 12 shows a structure of a semiconductor device according to an eleventh embodiment of the present invention.

FIG. 13 shows a structure of electronic apparatus according to a twelfth embodiment of the present invention.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

First Embodiment

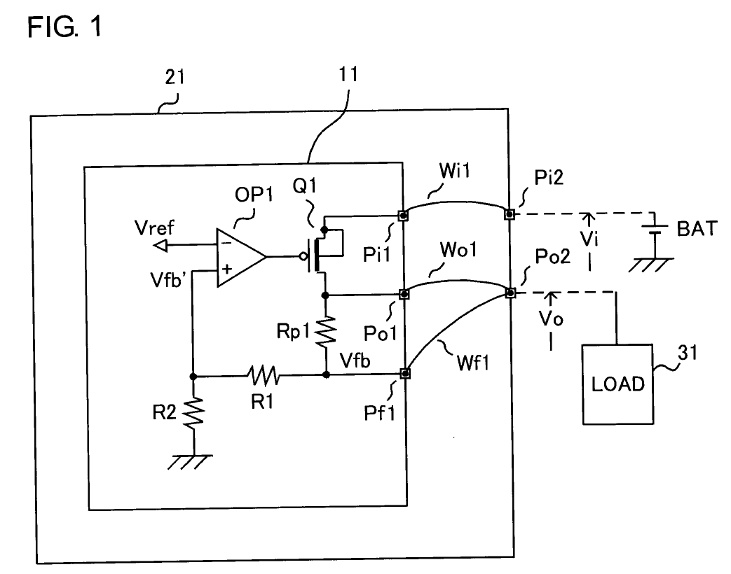

FIG. 1 shows a structure of a semiconductor device (IC device) according to a first embodiment of the present invention. In FIG. 1, an IC chip 11 constitutes a series regulator. A plurality of pads are formed on this IC chip 11, which include an input pad Pi1 for inputting input voltage Vi from a power source, an output pad Po1 for outputting voltage-adjusted output voltage Vo, and a feedback pad Pf1 for feeding back the output voltage Vo having been outputted, as a feedback voltage Vfb.

A P-type MOS transistor Q1, which is a voltage adjusting element, is connected between the input pad Pi1 and the output pad Po1. A protective resistor Rp1 is connected between the output pad Po1 and the feedback pad Pf1. The protective resistor Rp1 is so structured as to connect the output pad Po1 with the feedback pad Pf1 inside the IC chip 11. Thus, the possibility of failure due to disconnection thereof is very low.

A reference voltage Vref, which is an input signal, is inputted to the inverting input terminal (−) of an operational amplifier OP1, and a voltage-divided feedback voltage Vfb′, which is a feedback voltage Vfb divided by voltage-dividing resistors R1 and R2, is inputted to the non-inverting input terminal (+) of the operational amplifier OP1. An error amount of voltage corresponding to the difference between the reference voltage Vref and the voltage-divided feedback voltage Vfb′ is outputted from the operational amplifier OP1 and supplied to a gate of a transistor Q1. A control circuit is constituted by these operational amplifier OP1, transistor Q1 and voltage-dividing resistors R1 and R2.

A semiconductor device 21 is comprised of an IC chip 11 and a plurality of external terminals including an input terminal (hereinafter referred to as an input pin) Pi2 and an output terminal (hereinafter referred to as an output pin) Po2 both of which are lead terminals. The input pin Pi2 is connected to the input pad Pi1 by a bonding wire Wi1, and an output pin Po2 is connected to an output pad Po1 by a bonding wire Wo1. The output pin Po2 is also connected to the feedback pad Pf1 by a bonding wire Wf1. These bonding wires are normally formed by thin gold (Au) wires, and their resistance value is about 50 to 100 mΩ.

As shown by a broken line in FIG. 1, a battery BAT, which is a power source, is connected to the input pin Pi2, and an input voltage Vi (e.g., 4.5 V) is supplied. From the output pin Po2, an output voltage Vo (e.g., 3.0 V) is supplied to a load device 31.

In this semiconductor device 21, constant-voltage control is carried out in such a manner that the reference voltage Vref and a voltage-divided reference voltage Vfb′become equal to each other. The feedback pad Pf1 is provided in addition to the output pad Po1 and the feedback pad Pf1 is connected to the output pin Po2 by the bonding wire Wf1, so that the output voltage Vo at the output pin Po2 is fed back as a feedback voltage Vfb. As a result, the voltage drop (e.g., 100 mV) in the bonding wire Wo1 does not affect the output voltage Vo, thus improving the load regulation property.

In a further arrangement according to the present invention, a protective resistor Rp1 is connected between the output pad Po1 and the feedback pad Pf1 within the IC chip 11. Without this protective resistor Rp1 connected, the load device 31 will be damaged or destroyed if the bonding wire Wf1 is dislocated at the feedback pad Pf1 or the output pin Po2. This is because faulty contact or disconnection caused thereby disables feedback and raises the output voltage Vo to nearly the input voltage Vi.

Nevertheless, with the protective resistor Rp1 provided, the output voltage Vo at the output pad Po1 is fed back by the protective resistor Rp1 and the voltage-dividing resistors R1 and R2 even when there has occurred a faulty contact or disconnection at the bonding wire Wf1. Thus the rise in the output voltage Vo remains below a predetermined limit value, and damage to and failure of the load device 31 can be prevented.

The resistance value of this protective resistor Rp1 is set to meet certain conditions including: (1) the output voltage Vo at the feedback point (output pin Po2 in this case) must substantially be fed back accurately, (2) no damage or other trouble is caused to the load device 31 at a failure of normal feedback, and (3) a failure of normal feedback, should it happen, can be detected from a change (rise) in the output voltage Vo. It is preferable that the resistance value of the protective resistor Rp1, which is practically determined in relation to the resistance values of the voltage-dividing resistors R1 and R2, is set so as to raise the output voltage Vo by approximately 10 to 20 percent.

Such a failure of normal feedback may be detected by a comparison means provided on the IC chip 11 for comparing the output voltage Vo at the output pad Po1 with the reference voltage Vref or by a monitoring means provided to simply monitor the output voltage Vo at the output pad Po1. Or the arrangement may be such that the output voltage Vo is monitored at the output pin Po2.

In this manner, the load regulation can be improved irrespective of any voltage drop in the bonding wire Wo1 connecting the output pad Po1 and the output pin Po2, and abnormal rises in the output voltage Vo due to faulty connection in the voltage feedback path can be prevented.

Second and Third Embodiments

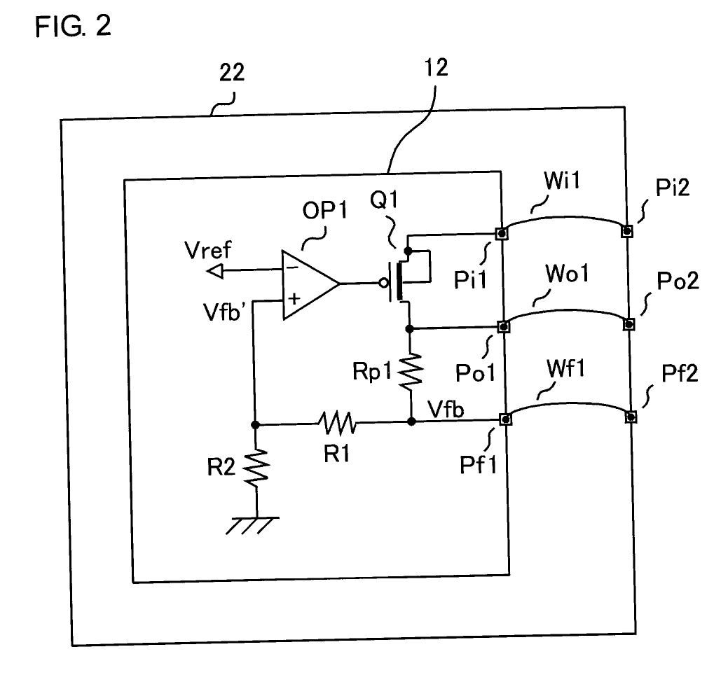

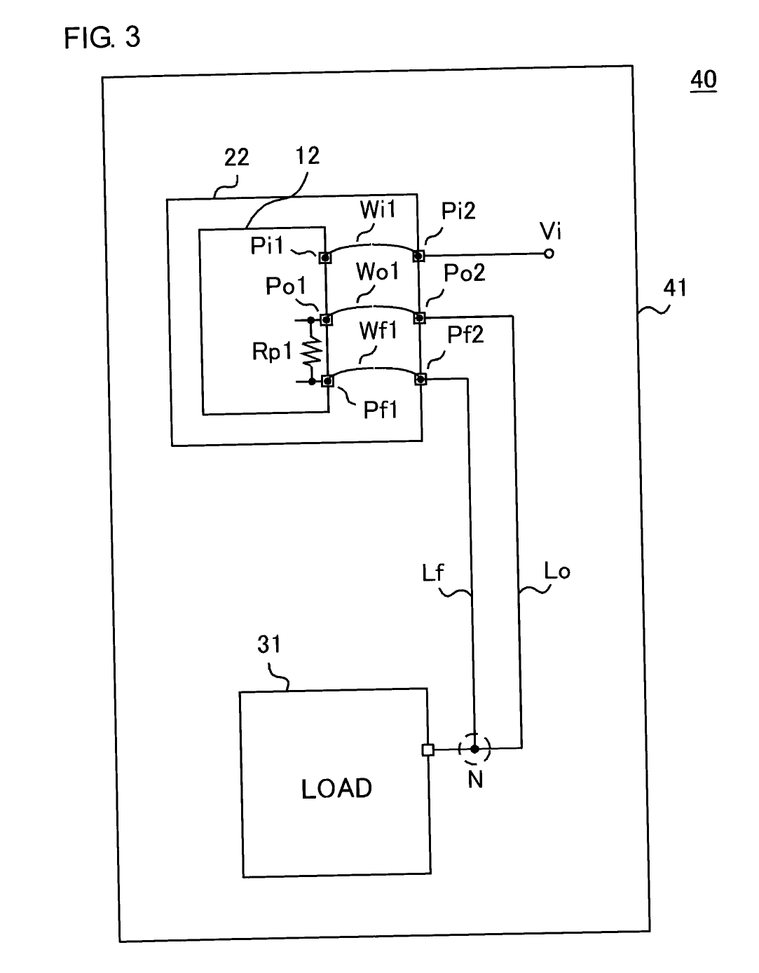

FIG. 2 shows a structure of a semiconductor device according to a second embodiment of the present invention. FIG. 3 shows a structure of electronic apparatus using the semiconductor device shown in FIG. 2, according to a third embodiment of the present invention.

In the semiconductor device 22 shown in FIG. 2, a feedback terminal (hereinafter referred to as a feedback pin) Pf2 is provided and is connected to a feedback pad Pf1 by a bonding wire Wf1. Outside the semiconductor device 22, therefore, the feedback pin Pf2 is connected to an output wiring connected to an output pin Po2 in order to feed back a feedback voltage Vfb. This semiconductor device 22 differs from the semiconductor device 21 shown in FIG. 1 in the way a feedback path is formed. Otherwise the structure thereof is the same as one shown in FIG. 1.

In an electronic apparatus 40 shown in FIG. 3, a semiconductor device 22 and a load device 31 are provided on a printed circuit board (hereinafter referred to as PCB) 41. An output pin Po2 of the semiconductor device 22 and an input terminal of the load device 31 are connected with each other by an output wiring Lo, which is a pattern wiring formed on the PCB 41. A feedback pin Pf2 of the semiconductor device 22 and a neighboring point N near the load device 31 of the output wiring Lo are connected with each other by a feedback wiring Lf, which is a pattern wiring. An output voltage Vo at this neighboring point N is fed back to a feedback pad Pf1. It is to be noted here that the feedback wiring Lf may be connected to an input terminal of the load device 31 instead of the neighboring point N. An input pin Pi2 is connected to a supply point of input voltage Vi by a pattern wiring.

In the electronic apparatus 40 shown in FIG. 3, the output voltage Vo at the neighboring point N near the input terminal of the load device 31 is fed back, so that the output voltage Vo at the neighboring point N is not affected by any voltage drop in the output wiring Lo between the semiconductor device 22 and the load device 31. Accordingly, even when the distance between the semiconductor device 22 and the load device 31 is long or even when the current to be supplied from the semiconductor device 22 to the load device 31 is large, a predetermined voltage may be supplied to the load device 31 without deteriorating the load regulation.

Where the output voltage Vo is fed back from the neighboring point N of the load device 31, there are greater possibilities not only for faulty connection due to a disconnection in the bonding wire Wf1 inside the semiconductor device 22 and the like but also for faulty connection in the feedback path due to faulty soldering of the feedback pin Pf2 and the feedback wiring Lf or a disconnection in the pattern wiring for the feedback wiring Lf.

According to the present invention, however, a protective resistor Rp1 is connected between an output pad Po1 and the feedback pad Pf1 within an IC chip 12, and therefore there is a minimal possibility of trouble, such as a disconnection of the protective resistor Rp1. Namely, even when there has occurred a faulty connection due to a faulty contact or disconnection in any of the feedback paths, the output voltage Vo at the output pad Po1 is fed back by the protective resistor Rp1 and the voltage-dividing resistors R1 and R2 in the same way as in the semiconductor device of FIG. 1, and thus the rise in the output voltage Vo remains below a predetermined limit value. Hence, damage to and failure of the load device 31 can be prevented.

As described above, an improvement of load regulation and an effective protection against faulty connection in the feedback path can be achieved by positioning a feedback point of the output voltage Vo near the load device 31 (that is, the neighboring point N) and at the same time providing the protective resistor Rp1 on a control circuit side of the feedback path.

Fourth and Fifth Embodiments

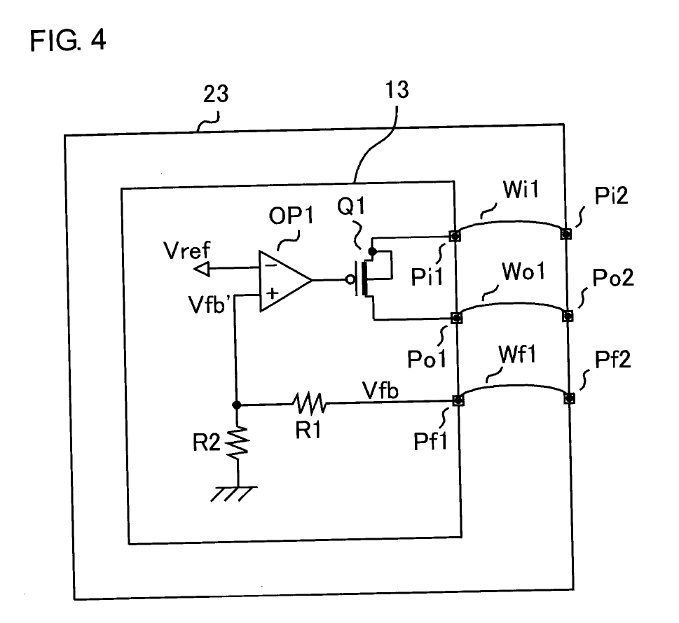

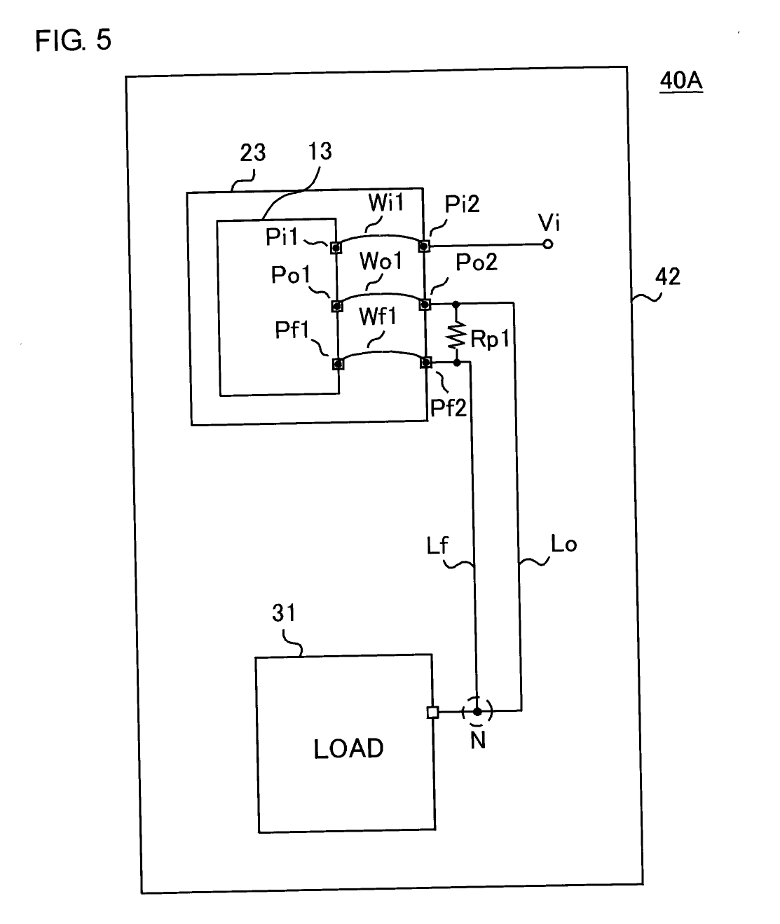

FIG. 4 shows a structure of a semiconductor device according to a fourth embodiment of the present invention. FIG. 5 shows a structure of electronic apparatus using the semiconductor device shown in FIG. 4, according to a fifth embodiment of the present invention.

A semiconductor device 23 shown in FIG. 4 differs from the semiconductor device 22 shown in FIG. 2 in that the protective resistor Rp1 is not provided between an output pad Po1 and a feedback pad Pf1. Otherwise the structure thereof is the same as one shown in FIG. 2.

An electronic apparatus 40A shown in FIG. 5 differs from the electronic apparatus 40 shown in FIG. 3 in that a protective resistor Rp1 is connected between an output wiring Lo and a feedback wiring Lf on a PCB 42. Otherwise the structure thereof is the same as one shown in FIG. 3.

In FIG. 5, it is preferable from the viewpoint of protection that the protective resistor Rp1 be connected as close to the semiconductor device as practicably possible between the output wiring Lo and the feedback wiring Lf. Moreover, the protective resistor Rp1 may be connected to an output pin Po2 and a feedback pin Pf2.

In the electronic apparatus 40A shown in FIG. 5, the protective resistor Rp1 is provided outside the semiconductor device 23, so that there is no protection against faulty or open connection in a bonding wire Wf1. However, even with an IC chip 13 unprocessed for a protective resistor Rp1, the protective resistor Rp1 may be connected as required on the PCB 42 to provide protection against open connection in the feedback path outside the semiconductor apparatus 23.

Thus, an improvement of load regulation and an effective protection against faulty connection in the feedback path can be achieved in the same way as with the electronic apparatus of FIG. 3.

Sixth Embodiment

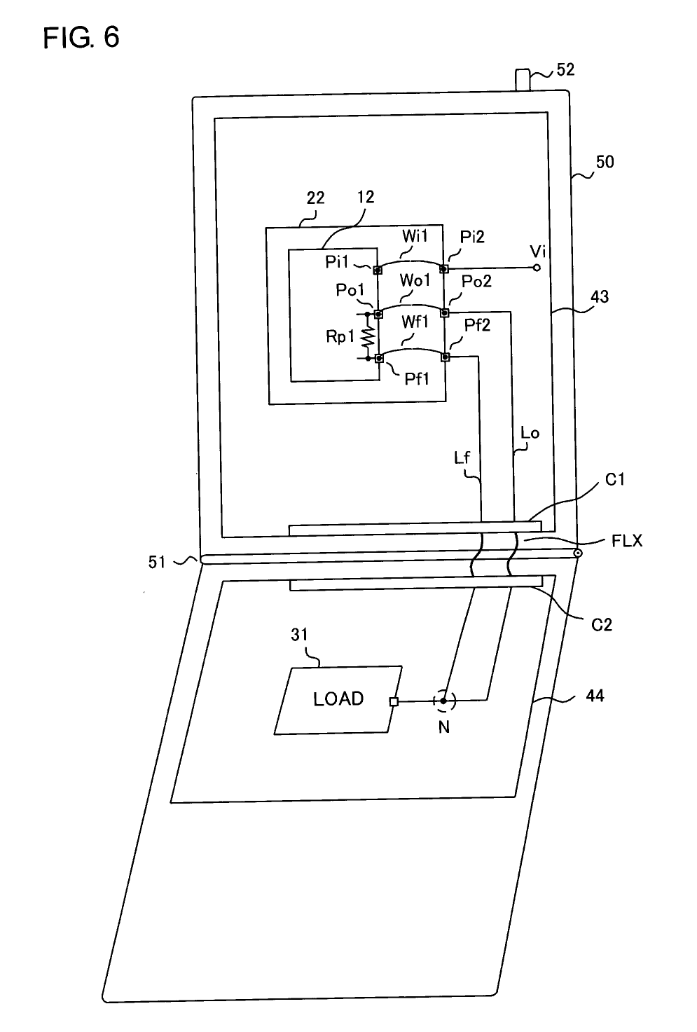

FIG. 6 shows a structure of electronic apparatus according to a sixth embodiment of the present invention. FIG. 6 shows an example of the present invention applied to a folding-type electronic apparatus, such as a foldable portable telephone.

In a folding-type electronic apparatus 50, a PCB 43 including a semiconductor device 22 as shown in FIG. 2 is provided in one half of a foldable structure, a PCB 44 including a load device 31 is provided in the other half thereof, and the PCBs 43 and 44 are foldably joined with each other by a folding joint 51. A reference numeral 52 shows an antenna.

Moreover, in the same way as with the electronic apparatus of FIG. 3, the semiconductor device 22 and the load device 31 are connected with each other via an output wiring Lo and a feedback wiring Lf. Connection at the folding joint 51 is accomplished by a connector C1, flexible wires FLX and a connector C2.

With the electronic device 50 of a folding structure, the feeding distance from the semiconductor device 22 to the load device 31 tends to be long and furthermore the mechanical structure at the folding joint 51 often causes a loss of reliability in electrical connection.

For this type of foldable electronic apparatus 50, the application of the present invention proves more effective in achieving an improvement of load regulation and an effective protection against faulty connection in the feedback path.

In the preferred embodiments so far described, the control circuit of IC chips 11, 12 and 13 has been described taking a series regulator as an example. However, the present invention may be applied not only to series regulators but also to other regulators such as switching regulators and charge-pump type regulators. Moreover, the present invention can be widely applied to audio output amplifiers and other apparatuses which include a voltage feedback circuit.

Seventh Embodiment

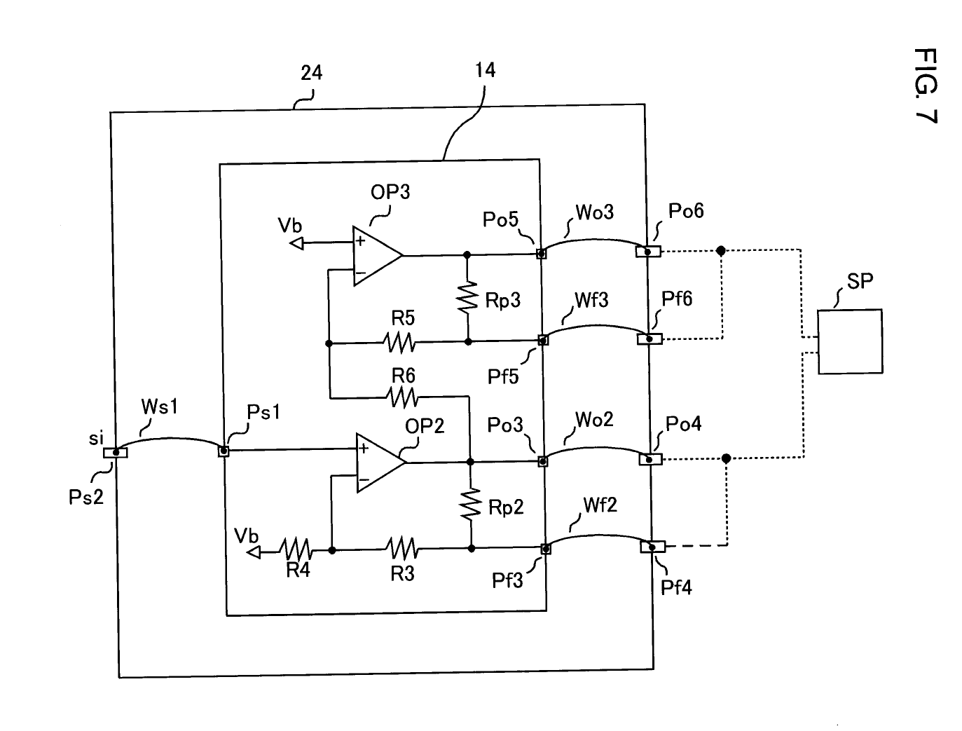

FIG. 7 shows a structure of an audio signal output apparatus of a BTL (Balanced Transformer-Less) configuration according to a seventh embodiment of the present invention.

In FIG. 7, an IC chip 14 represents an output amplifier of a BTL configuration. A plurality of pads are formed on this IC chip 14, which include an input pad Ps1 for inputting an input signal Si, an output pad Po3 for outputting a positive-side output signal, a feedback pad Pf3 for feeding back a positive-side output signal having been outputted externally, an output pad Po5 for outputting a negative-side output signal, and a feedback pad Pf5 for feeding back a negative-side output signal having been outputted externally.

A protective resistor Rp2 is connected between the output pad Po3 and the feedback pad Pf3, and a protective resistor Rp3 is connected between the output pad Po5 and the feedback pad Pf5.

An input signal Si is inputted to a non-inverting input terminal (+) of an operational amplifier OP2. And a voltage, obtained after a voltage between a feedback voltage at the feedback pad Pf3 and a reference bias voltage Vb is divided by resistors R3 and R4, is inputted to an inverting input terminal (−) of the operational amplifier OP2. An error amount of voltage corresponding to the difference between the input signal Si and the divided voltage is outputted from the operational amplifier OP2 and supplied to the output pad Po3.

The reference bias voltage Vb is inputted to a non-inverting input terminal (+) of an operational amplifier OP3. And a voltage, obtained after a voltage between a feedback voltage at the feedback pad Pf5 and an output voltage of the operational amplifier OP2 is divided by resistors R5 and R6, is inputted to the inverting input terminal (−) of the operational amplifier OP3.

A semiconductor device 24 is comprised of an IC chip 14 and a plurality of external terminals including a signal input pin Ps2, which is a lead terminal, a positive-side output pin Po4, a positive-side feedback pin Pf4, a negative-side output pin Po6 and a negative-side feedback pin Pf6. And the pins Ps2, Po4, Pf4, Po6 and Pf6 are connected to the pads Ps1, Po3, Pf3, Po5 and Pf5, respectively, by their respective bonding wires Ws1, Wo2, Wf2, Wo3 and Wf3.

Alternatively, the positive-side feedback pin Pf4 and the negative-side feedback pin Pf6 may be removed and the pads Pf3 and Pf5 may be connected to the pins Po4 and Po6 by the bonding wires Wf2 and Wf3, respectively.

In this audio signal output apparatus of a BTL configuration, a speaker SP is connected to the positive-side output pin Po4 and the negative-side output pin Po6, as shown by broken lines in FIG. 7, and is thus BTL-driven.

If the protective resistors Rp2 and Rp3 are not provided in an audio signal output apparatus as shown in FIG. 7, then a break in the feedback path due to a disconnection of bonding wire Wf2 for instance causes the output voltages of the operational amplifiers OP2 and OP3 to be offset to the upper limit and the lower limit, respectively. As a result thereof, a maximum current will keep flowing to the speaker SP, which is connected between the positive-side output pin Po4 and the negative-side output pin Po6.

However, according to the present embodiment, the protective resistors Rp2 and Rp3 are provided, so that no break will occur in the feedback path and there will only be a variation in AC gain. Thus, no large current will flow to damage the speaker SP.

By implementing a semiconductor device or an electronic apparatus according to the present embodiment, the load regulation can be improved irrespective of any voltage drop in the wire connecting the output pad with the output terminal and in the output wiring, and abnormal rises in the output voltage due to faulty connection in the voltage feedback path can be prevented.

Eighth Embodiment

An eighth embodiment of the present invention differs from the above-described other embodiments in that a diode is utilized to effectively detect an open failure of one wire of double wires. Japanese Patent Application Laid-Open No. Hei11-111785 discloses a technology for detecting a change in resistance value due to an open failure by a resistor connected between pads. According to the technology, however, a decision on a failure cannot be made unless a voltage drop is created by supplying a relatively large test current. Yet, some testers cannot supply large currents, and it is desirable that a weak current be used in the detection of a failure to avoid any heavy load on the wire by the test current. According to the present embodiment, on the other hand, there is provided a semiconductor device that can achieve the failure judgment even with a weak test current.

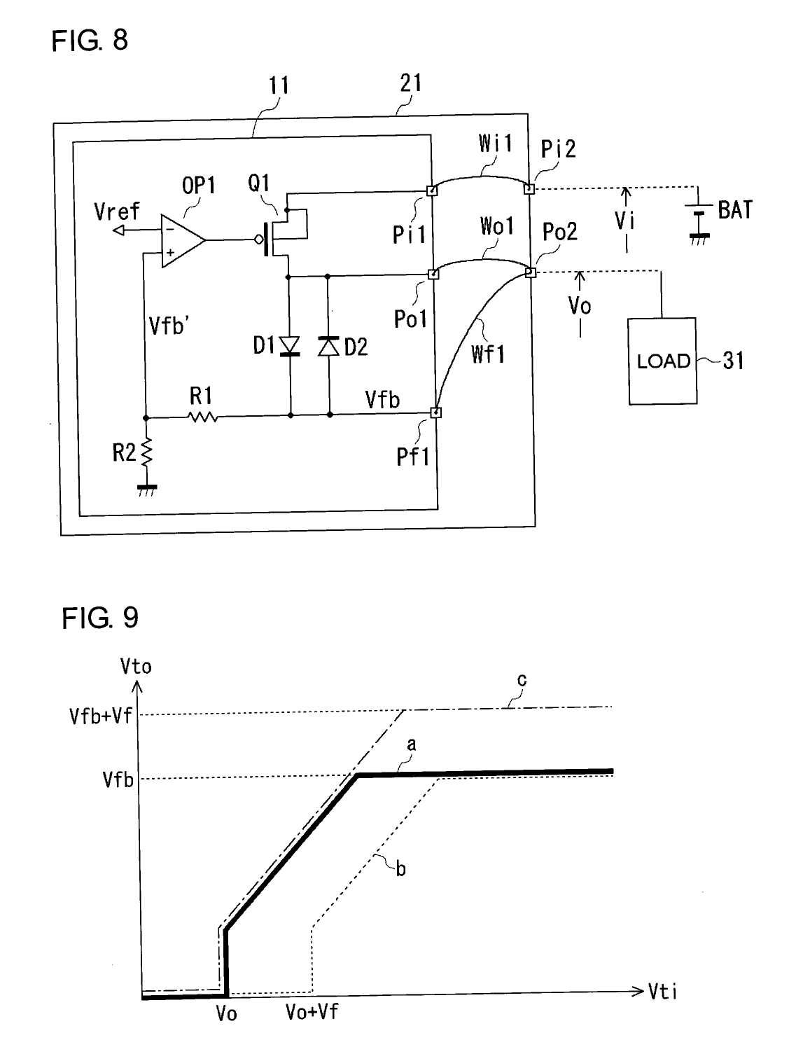

FIG. 8 shows a circuit of a semiconductor device according to an eighth embodiment of the present invention. The eighth embodiment differs from the circuit of the first embodiment in that the protective resistor is replaced by diodes. A PMOS-type transistor Q1 is connected between an input pad Pi1 and an output pad Po1. Connected between the output pad Po1 and a feedback pad Pf1 are a first diode D1, for which the forward direction is from the former to the latter, and a second diode D2 for which the direction is opposite thereto. It is to be noted here that the second diode D2 may be omitted because it is not used for the detection of a wire open failure as will be mentioned later. In what is to follow, the first and second diodes D1 and D2 are collectively referred to simply as a “diode” also.

FIG. 9 shows a detecting principle of the wire open failure. In the test, a voltage rising gradually from zero (hereinafter referred to as “test input voltage” and denoted by Vti) is applied to an input terminal Pi2, and at the same time the voltage appearing at an output terminal Po2 (hereinafter referred to as “test output voltage” and denoted by Vto) is observed. The graph shows the behaviors of Vto in relation to Vti in a thick solid line (a) when the device being tested is normal, in a broken line (b) when the output wire Wo1 is broken, and in a chain line (c) when the feedback wire Wf1 is broken. Where any two lines overlap, they are shown in two separate lines for reasons of clarity.

(1) Where the device is normal:

Vto does not make its appearance effectively until Vti=V0. V0 is equivalent to a source-drain voltage or Vds when the transistor Q1 starts operating. Then Vto increases linearly until Vto=Vfb. After that, Vto remains constant at Vto=Vfb.

(2) Where the output wire Wo1 is broken:

Vto does not make its appearance effectively until Vti=V0+Vf. Vf is a forward voltage drop of the transistor Q1 because Vto goes out of the drain of the transistor Q1, passes through a first transistor D1 and the feedback wire Wf1 and appears at the output terminal Po2. Thus, a failure can be detected in this reduced voltage test.

(3) Where the feedback wire Wf1 is broken:

Vto makes its appearance effectively when Vti=V0. Thereafter, Vto increases linearly in the same manner as the above (1). The Vto, however, does not stop at Vto=Vfb but keeps increasing until Vto=Vfb+Vf. From then on, the Vto remains constant at the same level because Vfb′ appears as a voltage when the output voltage has passed through the first transistor D1. Thus, a failure can be detected in this reduced voltage test, too.

In addition to the above, there may be caused an open failure of input wire Wi1. In such a case, the detection is easy because Vto does not appear with Vti changed.

As has been described, by implementing the structure realized by the eighth embodiment where diodes are utilized, the detection of wire open failures can be realized by a test using a diode and weak current. Moreover, even when one of the wires is broken, the diode maintains the output voltage and the feedback voltage at values relatively close to each other, so that there will be reduced possibilities of too large output voltage causing damage to the load device 31.

Ninth Embodiment

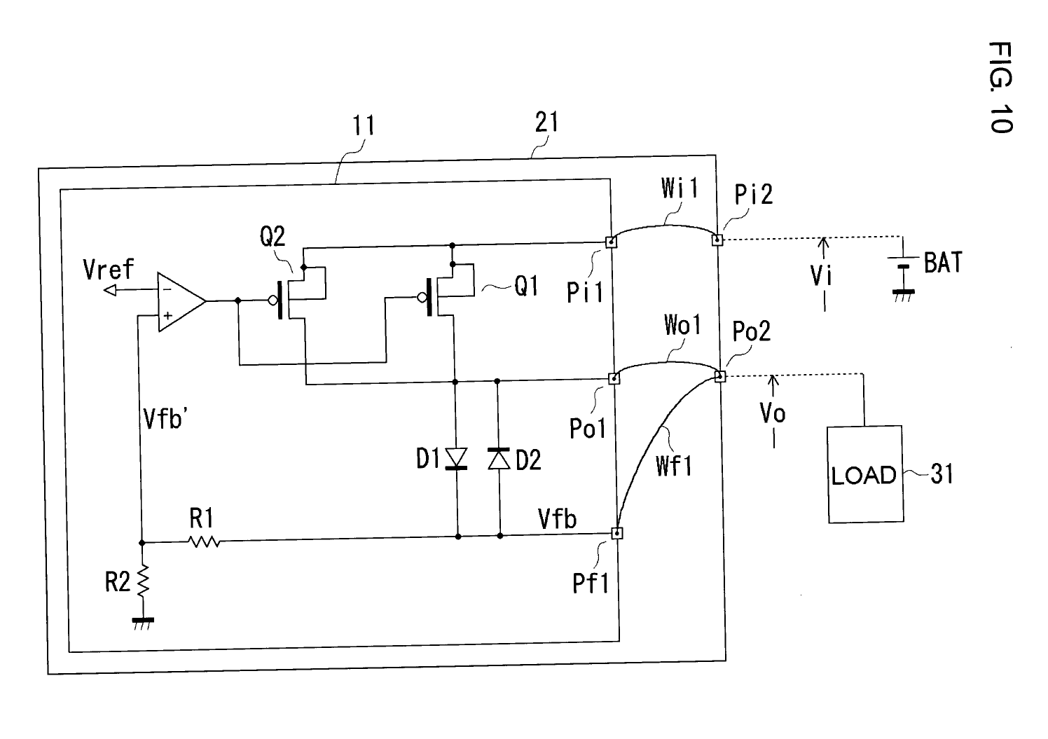

FIG. 10 shows a circuit of a semiconductor device according to a ninth embodiment of the present invention. Hereinbelow, the structure substantially equal to that of the eighth embodiment is designated by the same reference numerals, and the description thereof is omitted as appropriate. The ninth embodiment differs from the eighth embodiment in that there are two transistors used for a regulator. The first transistor Q1 is disposed the same way as in the eighth embodiment. Gate, source and drain of an additional second transistor Q2 are also the same as those of the first transistor Q1, and connected. Thus, the second transistor Q2 functions the same way as the first transistor Q1. In this ninth embodiment, the placement of two transistors can ensure a necessary drive ability even if each of the transistors is relatively small in size. The detection of wire open failures realized by the structure according to the ninth embodiment is equivalent to that of the eighth embodiment.

Tenth Embodiment

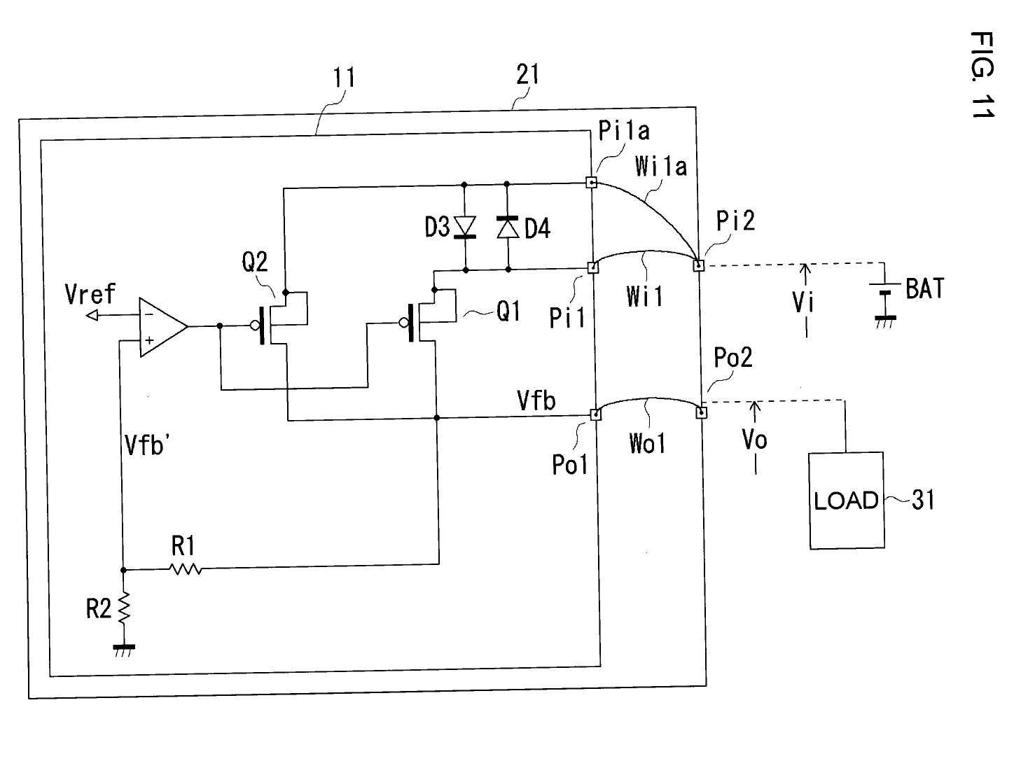

FIG. 11 shows a circuit of a semiconductor device according to a tenth embodiment of the present invention. Hereinbelow, the structure substantially equal to that of the ninth embodiment is designated by the same reference numerals, and the description thereof is omitted as appropriate. The tenth embodiment differs from the ninth embodiment in that two pads are provided on the input side instead of the output side and diodes are provided on that side. Accordingly, the structure of this tenth embodiment is such that a control circuit receives the battery voltage by two systems, or two pads, to generate a target voltage. Referring to FIG. 11, a second input pad Pi1a is newly provided and is connected to an input terminal Pi2 by a wire. On the other hand, the feedback pad Pf1 is disused, the first and second diodes D1 and D2 are also disused, and the drains of both the first and second transistors Q1 and Q2 are directly connected to an output pad Po1. While a source of the first transistor Q1 is the same as in the ninth embodiment, a source of the second transistor Q2 is connected to a newly installed input pad Wi1a. And connected between the drains of the second transistor Q2 and the first transistor Q1 are a third diode D3 for which the forward direction is from the former to the latter and a fourth diode D4 for which the direction is opposite. In this arrangement according to the present embodiment, wire open failures are detected as follows:

(1) Where the newly installed input wire Wi1a is broken:

Since the source voltage of the second transistor Q2 drops from Vti by as much as the forward voltage drop Vf of the fourth diode D4, the proportion of “on” of the second transistor Q2 becomes smaller. As a result, the drive ability of an IC chip 11 as a whole drops, and therefore a wire open failure can be detected by monitoring the drive current at an output terminal Po2. Even when the wire Wi1a is broken, having the second transistor Q2 operate to a certain degree can prevent an excessive load from working on the first transistor Q1.

(2) Where the input wire Wi1 existing from the beginning is broken:

Such a wire open failure can be detected by the method similar to (1) above.

(3) Where the original wire Wo1 is broken:

The detection is easy because Vto does not appear with Vti changed.

Eleventh Embodiment

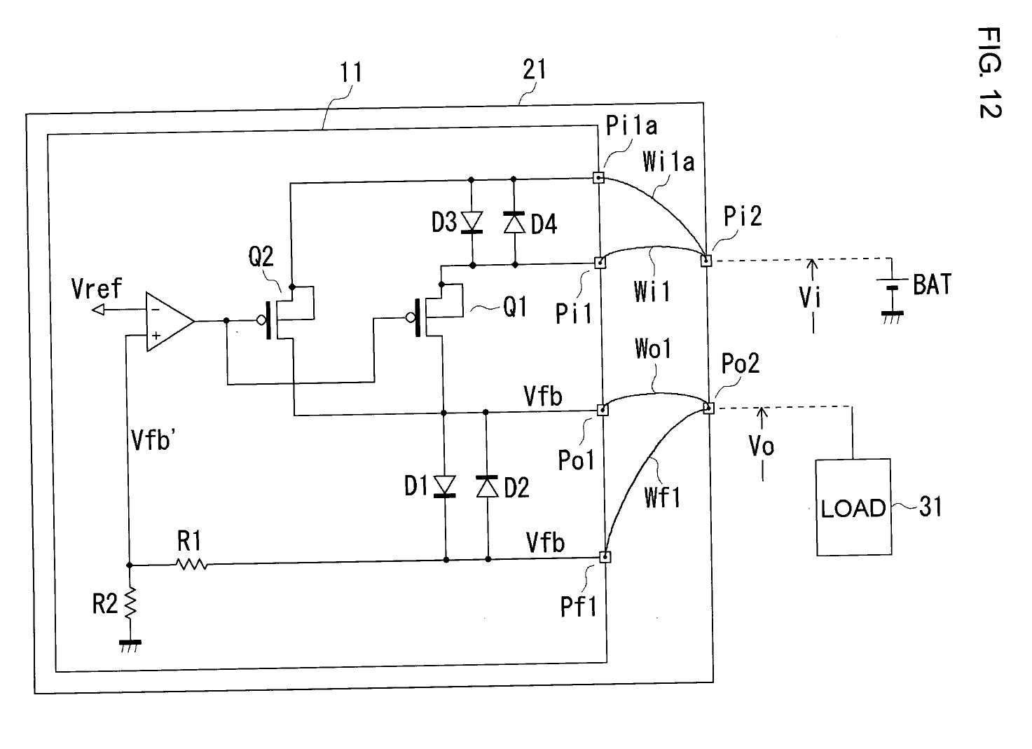

FIG. 12 shows a circuit of a semiconductor device according to an eleventh embodiment of the present invention. In this eleventh embodiment, where the ninth and third embodiments are combined, two pads are provided on each of the input side and the output side. That is, the structure on the input side is the same as that of the tenth embodiment, and the structure on the output side is the same as that of the ninth embodiment. Thus, an open wire failure on the input side can be detected the same way as in the tenth embodiment, and an open wire failure on the output side may be detected the same way as in the ninth embodiment.

The eleventh embodiment has the same advantageous effects as the ninth and third embodiments. Firstly, the structure according to the present embodiment realizes the detection of an open wire failure with a weak current. Furthermore, even when a wire on the output side breaks, damage is hardly caused to the load device 31. Moreover, even when a wire on the input side breaks, it is less likely that both the transistors suffer from the overload. This eleventh embodiment with duplicated paths on both input and output sides is suited for large-current drive.

Twelfth Embodiment

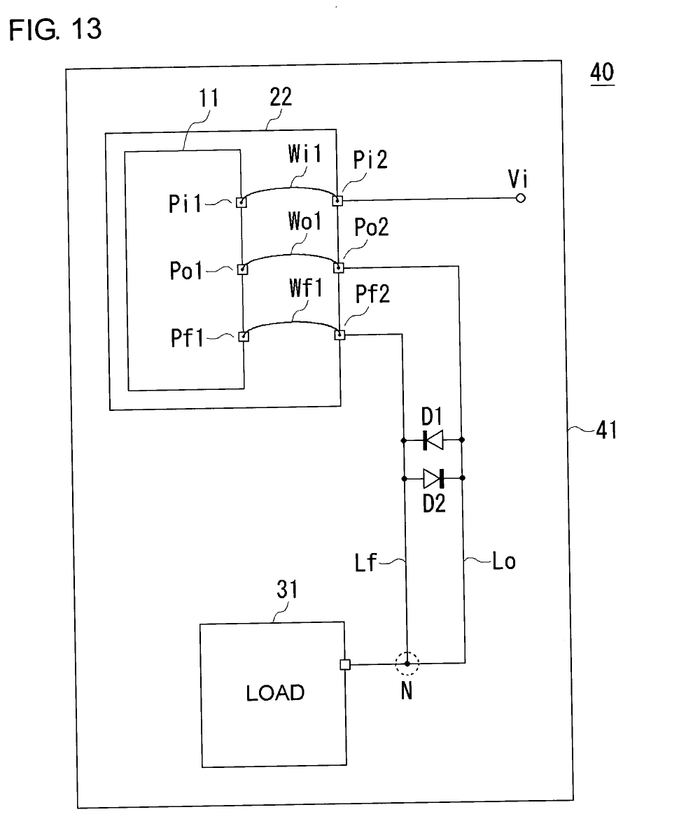

FIG. 13 is a diagram showing a conceptual structure of an electronic apparatus 40 provided with a semiconductor device according to the eighth embodiment. Here, the diodes, which are provided inside the semiconductor device 21 according to the eighth embodiment, are now provided outside the semiconductor device 21. Furthermore, while the output pin Po2 serves also as a feedback pin in the eighth embodiment, a feedback pin Pf2 is newly provided in this twelfth embodiment.

A semiconductor device 21 and a load device 31 are mounted on a printed circuit board 41 in the electronic apparatus 40. An output terminal Po2 of the semiconductor device 21 and an input terminal of the load device 31 are connected with each other by an output wiring Lo formed on the printed circuit board 41. The dedicated feedback pin Pf2 of the semiconductor device 21 and a point N on the output wiring Lo are connected with each other by a feedback wiring Lf. An input voltage Vi is applied to an input terminal Pi2 via a pattern wiring. A first diode D1 is connected on the printed circuit board 41 in the direction from the output wiring Lo toward the feedback wiring Lf, and a second diode D2 is connected thereon in the opposite direction.

By implementing the above-described structure, the same advantageous effects as in the eighth embodiment, namely, the protection of the load device 31, and the detection of an open wire failure are accomplished easily even when a diode is not provided inside the semiconductor device 21. According to the present embodiment, not only an open wire failure within the semiconductor device 21 in the PCB package test process but also an open failure due to faulty soldering of the output pin Po2 or the dedicated feedback pin Pf2 in the mounting of the semiconductor device 21 on the printed circuit board 41 can also be detected.

The present invention has been described based on the embodiments which are only exemplary. It is understood by those skilled in the art that there exist other various modifications to the combination of each component and process described above and that such modifications are encompassed by the scope of the present invention.

In the above embodiments, a MOS transistor is used as an example. It goes without saying that the transistor may be of a bipolar type.

In the above embodiments, the control circuit has been described as a series regulator. However, the control circuit may be equipped with such other regulator as a switching regulator or a charge-pump type regulator.

Although the present invention has been described by way of exemplary embodiments, it should be understood that many changes and substitutions may further be made by those skilled in the art without departing from the scope of the present invention which is defined by the appended claims.

What is claimed is:

1. A semiconductor device, including:
an IC chip including:
a control circuit which, based on an input signal and a feedback signal in which an output voltage is fed back, controls the output voltage;
an output pad for outputting the output voltage; and
a feedback pad for inputting the feedback signal; and
a protective resistor connected between the output pad and the feedback pad.

2. A semiconductor device, including:
an IC chip including:
a control circuit which, based on an input signal and a feedback signal in which an output voltage is fed back, controls the output voltage; and
an output pad for outputting the output voltage; and
a feedback pad for inputting the feedback signal;
an output terminal connected to the output pad; and
a feedback terminal connected to the feedback pad.

3. A semiconductor device according to claim 2, wherein said IC chip includes a protective resistor connected between the output pad and the feedback pad.

4. An electronic apparatus, comprising:
a semiconductor device including:
an IC chip including:
a control circuit which, based on an input signal and a feedback signal in which an output voltage is fed back, controls the output voltage;
an output pad for outputting the output voltage;
a feedback pad for inputting the feedback signal; and
a protective resistor connected between the output pad and the feedback pad; and
an output terminal connected to the output pad; and
a feedback terminal connected to the feedback pad;
a load device which includes an input terminal;
an output interconnection which connects the output terminal with the input terminal of said load device and which supplies an output of said semiconductor device to said load device; and
a feedback interconnection which connects the feedback terminal with the input terminal of said load device or said output interconnection and which feeds back a voltage supplied to said load device, to said semiconductor device.

5. An electronic apparatus, comprising:
a semiconductor device including:
an IC chip including:
a control circuit which, based on an input signal and a feedback signal in which an output voltage is fed back, controls the output voltage;
an output pad for outputting the output voltage; and
a feedback pad for inputting the feedback signal;
an output terminal connected to the output pad; and
a feedback terminal connected to the feedback pad;
a load device which includes an input terminal;
an output interconnection which connects the output terminal with the input terminal of said load device and which supplies an output of said semiconductor device to said load device;
a feedback interconnection which connects the feedback terminal with the input terminal of said load device or said output interconnection and which feeds back a voltage supplied to said load device, to said semiconductor device; and
a protective resistor connected between said output interconnection and said feedback interconnection.

6. A semiconductor device, including:
an IC chip which includes a first pad and a second pad; and
a terminal connected to both the first pad and the second pad,
wherein a fist signal connected to said first pad and a second signal connected to said second pad are coupled by a diode.

7. A semiconductor device according to claim 6 wherein said terminal is an input terminal, the semiconductor device further including:
a control circuit which generates a target voltage from a power supply voltage when the power supply voltage is applied to the input terminal; and
an output terminal which outputs the thus generated target voltage,
wherein said control circuit is structured such that the power supply voltage is received by two systems of the fist signal and the second signal so as to generate the target voltage by the two systems.

8. A semiconductor device according to claim 6 wherein said terminal is an output terminal, the semiconductor device further including:
an input terminal to which a predetermined power supply voltage is applied; and
a control circuit which generates a target voltage from the power supply voltage,
wherein the target voltage is applied to either the first signal or the second signal.

9. A semiconductor device, including:
an input terminal to which a power supply voltage is applied;
a control circuit which generates a target voltage from the power supply voltage; and
an output terminal which outputs the thus generated target voltage,
wherein at an IC chip side there are provided a plurality of pads for use with at least one of said input terminal and said output terminal, so as to have duplicated signal transmission paths for the at least one of said input terminal and said output terminal, and wherein a diode is coupled between the duplicated signal transmission paths therefor.

10. An electronic apparatus, including:
a semiconductor device including:
an input terminal to which a power supply voltage is applied;
a control circuit which generates a target voltage from the power supply voltage; and
an output terminal which outputs the thus generated target voltage; and
a load device,
wherein at an IC chip side there are provided a plurality of pads for use with at least one of said input terminal and said output terminal, so as to have duplicated signal transmission paths for the at least one of said input terminal and said output terminal, and wherein the duplicated signal transmission paths therefor are coupled by a diode at points inside said semiconductor device or between said semiconductor device and said load device.
